(19) United States
(12) Patent Application Publication
(10) Pub. No.: US 2026/0313681 A1
(43) Pub. Date: Oct. 8, 2026

(54) RESOURCE SELECTION FOR MULTIPLE DESTINATIONS

(71) Applicant: InterDigital Patent Holdings, Inc., Wilmington, DE (US)

(72) Inventors: Martino M. Freda, Laval (CA); Oumer Teyeb, Montreal (CA); Tuong Duc Hoang, Montreal (CA); Ananth Kini, Conshohocken, PA (US)

(73) Assignee: InterDigital Patent Holdings, Inc., Wilmington, DE (US)

(21) Appl. No.: 19/482,051

(22) PCT Filed: Jun. 5, 2024
(86) PCT No.: PCT/US2024/032563

§ 371 Date: Nov. 6, 2025

Related U.S. Application Data
(60) Provisional application No. 63/471,147, filed on Jun. 5, 2023.

(51) Int. Cl. H04W 72/566; H04W 28/02; H04W 72/40; H04W 88/04

(52) U.S. Cl. CPC H04W 72/569; H04W 28/0236; H04W 28/0252; H04W 72/40; H04W 88/04

(57) ABSTRACT

Systems, methods, devices, and instrumentalities are described herein related to resource selection for multiple destinations. A device (e.g., a wireless transmit/receive unit (WTRU)) may receive information that indicates a first packet delay budget (PDB) associated with a first relay WTRU and/or a second PDB associated with a second relay WTRU. The device may determine that there is data to be sent. The device may determine a resource selection window based on one condition of a first condition or a second condition being satisfied. The first condition may be satisfied if a congestion indication is received from the second relay WTRU and the second PDB is larger than the first PDB. The second condition may be satisfied if the congestion indication is not received from the second relay WTRU, the second PDB is larger than the first PDB, and a channel busy ratio (CBR) meets or is greater than a threshold.

### CROSS-REFERENCE TO RELATED APPLICATIONS

This application claims the benefit of U.S. Provisional Patent Application No. 63/471,147, filed Jun. 5, 2023, the contents of which are hereby incorporated by reference herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, devices, and instrumentalities are described herein related to resource selection for multiple destinations.

A device (e.g., a wireless transmit/receive unit (WTRU)) may include a processor configured to perform one or more actions. The device may be configured to receive information that indicates a first packet delay budget (PDB) associated with a first relay WTRU and a second PDB associated with a second relay WTRU. The WTRU may determine that there is data to be sent. The WTRU may determine a resource selection window based on one condition of a first condition or a second condition being satisfied. The determination that there is data to be sent may trigger the determination of the resource selection window. The first condition being satisfied may include that a congestion indication is received from the second relay WTRU and the second PDB is larger than the first PDB. The second condition being satisfied may include that the congestion indication is not received from the second relay WTRU, the second PDB is larger than the first PDB, and a channel busy ratio (CBR) meets or is greater than a threshold. The WTRU may determine a resource within the determined resource selection window. The WTRU may send the data. The data may be sent via at least the determined resource.

In examples, the one condition that may be satisfied is the first condition. Based at least on the reception of the congestion indication from the second relay WTRU and the second PDB being larger than the first PDB, the WTRU may determine that the resource selection window is the first PDB. The determination that the resource selection window is the first PDB may include a determination to use a value of the first PDB for the resource selection window. The determination that the resource selection window is the first PDB may be further based on the first PDB being a smallest PDB among relays available to the WTRU for transmission of the data.

In examples, the one condition that is satisfied may be the second condition. Based at least on the lack of the reception of the congestion indication from the second relay WTRU, the second PDB being larger than the first PDB, and the determination that the CBR meets or is greater than the threshold, the WTRU may determine that the resource selection window is the second PDB. The determination that the resource selection window is the second PDB may be further based on the second PDB being a maximum PDB among relays available to the WTRU for transmission of the data. The device may determine the CBR.

Based on the determined resource being after one PDB of the first PDB or the second PDB, the WTRU may determine that there is a restriction for a sidelink logical channel associated with a relay WTRU that is associated with the one PDB. The relay WTRU may be the first relay WTRU or the second relay WTRU. The WTRU may determine a smallest PDB from among the first PDB or the second PDB. The WTRU may select the first relay WTRU if the first PDB is the smallest PDB or select the second relay WTRU if the second PDB is the smallest PDB.

A method associated with a wireless transmit/receive unit (WTRU) may include receiving information that indicates a first packet delay budget (PDB) associated with a first relay WTRU and/or a second PDB associated with a second relay WTRU. The method may include determining that there is data to be sent. The method may include determining a resource selection window based on one condition of a first condition or a second condition being satisfied. The first condition may be satisfied if a congestion indication is received from the second relay WTRU and/or the second PDB is larger than the first PDB. The second condition may be satisfied if the congestion indication is not received from the second relay WTRU, the second PDB is larger than the first PDB, and/or a channel busy ratio (CBR) meets or is greater than a threshold.

The method may include determining a resource within the determined resource selection window. The method may include sending the data, wherein the data is sent via at least the determined resource.

The method may include one or more features as described herein. In examples, the one condition that is satisfied may be the first condition. Based at least on the reception of the congestion indication from the second relay WTRU and/or the second PDB being larger than the first PDB, the method may include determining that the resource selection window is the first PDB. The determination that the resource selection window is the first PDB may include determining to use a value of the first PDB for the resource selection window.

The determination that the resource selection window is the first PDB may be further based on the first PDB being a smallest PDB among relays available to the WTRU for transmission of the data.

The one condition that is satisfied may be the second condition. Based at least on the lack of the reception of the congestion indication from the second relay WTRU, the second PDB being larger than the first PDB, and/or the determination that the CBR meets or is greater than the threshold, the method may include determining that the resource selection window is the second PDB.

The determination that the resource selection window is the second PDB may be further based on the second PDB being a maximum PDB among relays available to the WTRU for transmission of the data. The method may include determining the CBR.

Based on the determined resource being after one PDB of the first PDB or the second PDB, the method may include determining that there is a restriction for a sidelink logical channel associated with a relay WTRU that is associated with the one PDB. The relay WTRU may be the first relay WTRU or the second relay WTRU. The method may include determining a smallest PDB from among the first PDB or the second PDB. The method may include selecting the first relay WTRU if the first PDB is the smallest PDB or selecting the second relay WTRU if the second PDB is the smallest PDB. The determination that there is data to be sent may trigger the determination of the resource selection window.

A device (e.g., a wireless transmit/receive unit (WTRU) may include a processor configured to perform one or more actions. The device may receive an indication from a first relay WTRU that that indicates a first packet delay budget (PDB) and an indication from a second relay WTRU that that indicates a second PDB. The device may determine that there is data to be sent. The device may perform resource selection that includes determining a resource selection window.

The second PDB may be larger than the first PDB. The device may receive an indication of congestion from the second relay WTRU. The determination of the resource selection window may be based on the indication of congestion from the second relay WTRU and the second PDB being larger than the first PDB. The device may determine the resource selection window is a minimum PDB from the first PDB and the second PDB.

The device may determine that a channel busy ratio meets or is greater than a threshold. The determination of the resource selection window may be based at least on the channel busy ratio meeting or being greater than the threshold. The device may, based at least on the channel busy ratio meeting or being greater than the threshold, determine the resource selection window is a maximum PDB from the first PDB and the second PDB. The determination that the resource selection window is a maximum PDB from the first PDB and the second PDB by the device may further be based on not having received an indication of congestion from a relay WTRU with a largest PDB.

The device may determine that a grant has a logical channel prioritization restriction associated with the destination if a selected resource occurs after a PDB associated with a destination.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a remote WTRU that is out of coverage.

FIG. 3A illustrates an example user plane protocol stack.

FIG. 3B illustrates an example control plane protocol stack.

FIG. 4 illustrates an example LCH that may take different paths.

### DETAILED DESCRIPTION

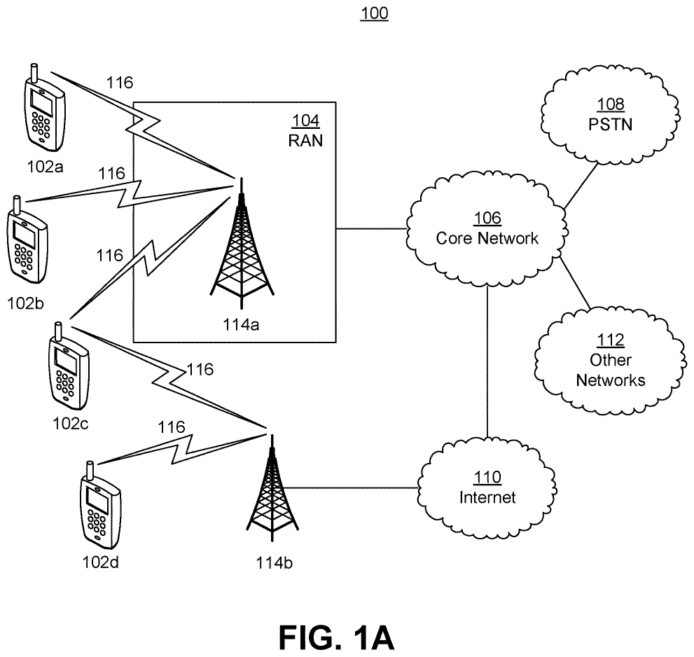

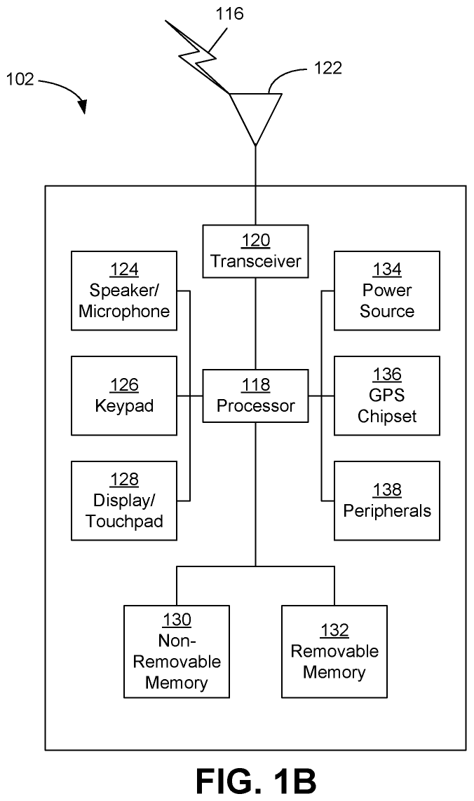

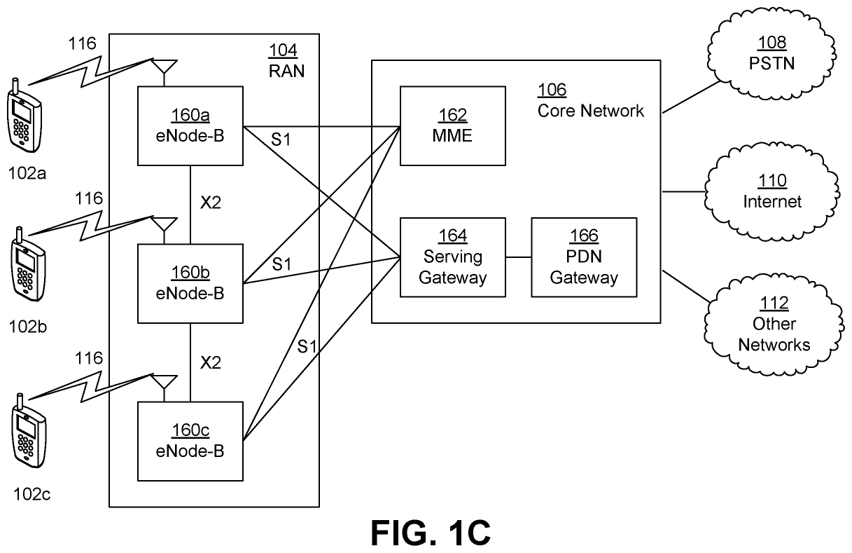

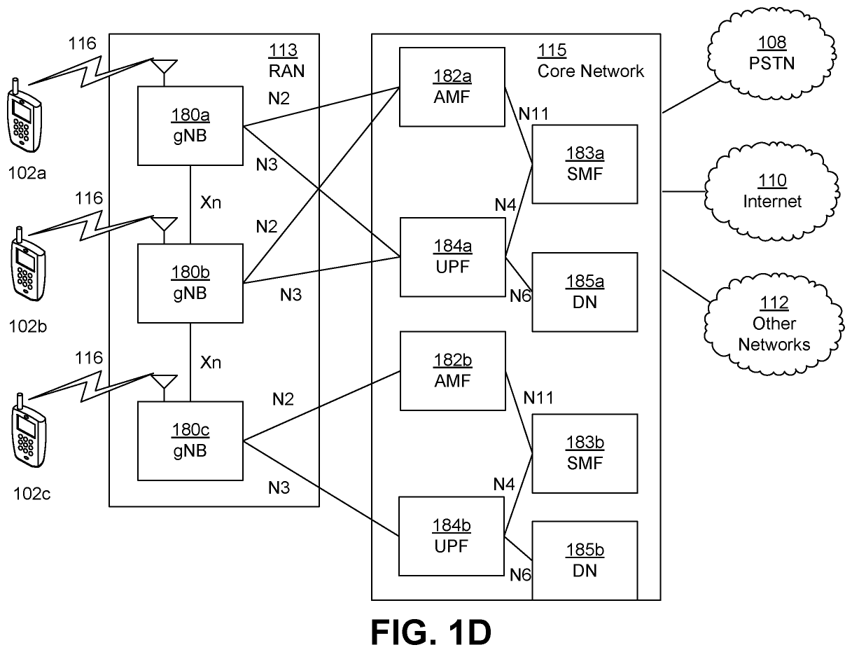

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Feature(s) associated with using a WTRU as a WTRU to network relay for out of coverage (OOC) WTRUs are provided herein.

An SL-based WTRU may be used as a WTRU-to-network relay. Sidelink relays may be introduced to support WTRU-to-network relay (e.g., U2N Relay) functionality. Sidelink relays may provide connectivity to a network for U2N Remote WTRU(s). Relay architectures (e.g., L2 and L3 U2N) may be supported. An L3 U2N relay architecture may be transparent to a serving RAN of a U2N Relay WTRU (e.g., except for controlling sidelink resources).

A relay WTRU (e.g., a U2N Relay WTRU) may be in RRC_CONNECTED (e.g., to perform relaying of unicast data). For relay operation (e.g., L2 U2N relay operation), one or more of the following RRC state combinations may be supported: a relay WTRU and a remote WTRU (e.g., a U2N relay WTRU and a U2N remote WTRU) may be in RRC CONNECTED (e.g., to perform transmission/reception of relayed unicast data); and/or a relay WTRU (e.g., a U2N relay WTRU) may be in RRC_IDLE, RRC_INACTIVE or RRC_CONNECTED provided remote WTRU(s) (e.g., U2N remote WTRU(s)) that may be connected to a relay WTRU (e.g., U2N relay WTRU) are in RRC_INACTIVE or in RRC_IDLE.

For a relay (e.g., L2 U2N relay), a remote WTRU (e.g., U2N remote WTRU) may be configured to use resource allocation mode 2 (e.g., for data to be relayed).

A unicast link (e.g., single unicast link) may be established between a relay WTRU (e.g., a L2 U2N relay WTRU) and a remote WTRU (e.g., one L2 U2N remote WTRU). Traffic of a remote WTRU (e.g., a U2N remote WTRU) via a given relay WTRU (e.g., a U2N relay WTRU) and traffic of the relay WTRU (e.g., a U2N relay WTRU) may be separated in different channels (e.g., different Uu RLC channels over Uu).

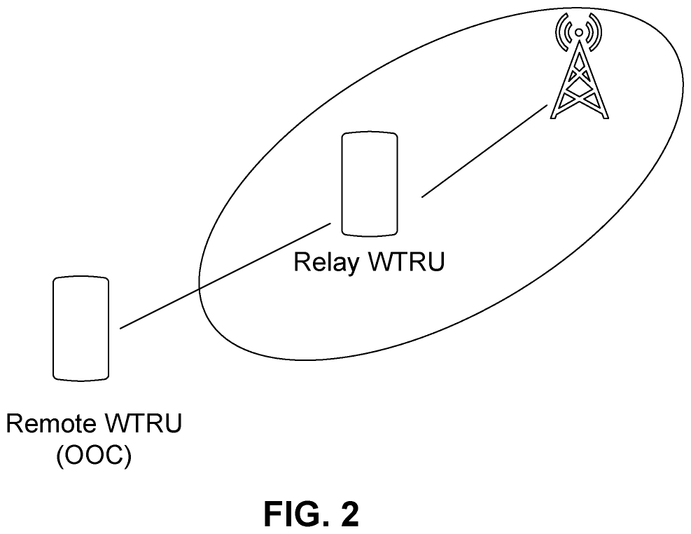

A remote WTRU may be out of coverage as depicted in FIG. 2.

A use case of layer 2 WTRU-to-network relays may be to serve a remote WTRU that is out of coverage. Multipath may be used. In multipath, a remote WTRU may be assumed to be in coverage and may utilize (e.g., either) Uu path, SL (e.g., relayed) path, or both.

Feature(s) associated with relay protocol architecture are provided herein.

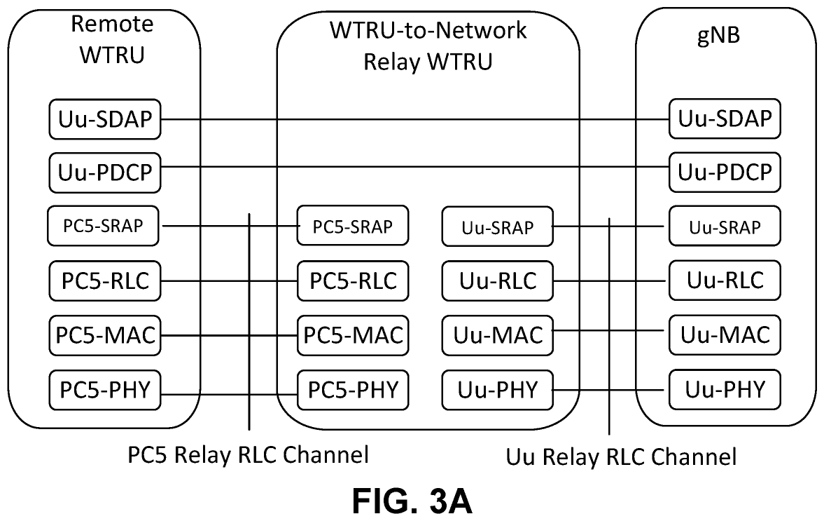

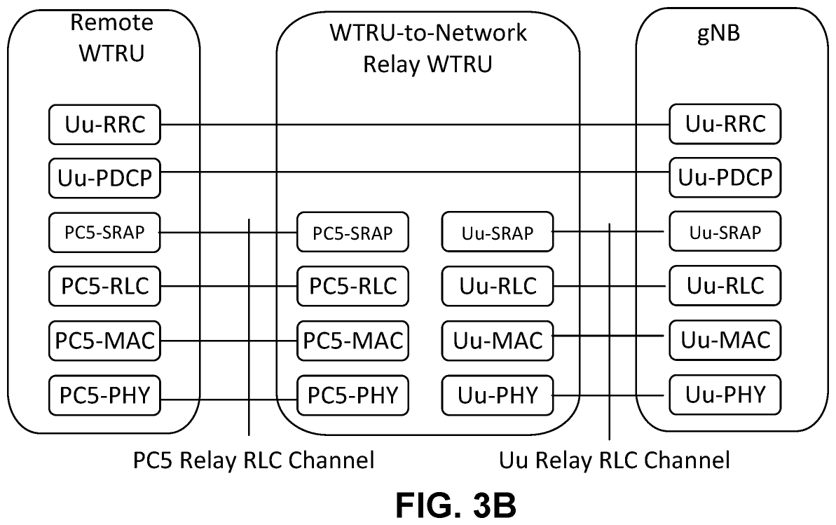

Example protocol stacks for a user plane and a control plane of a relay architecture (e.g., L2 U2N Relay architecture) are depicted in FIGS. 3A-3B. FIG. 3A depicts an example user plane protocol stack for L2 WTRU-to-Network relay. FIG. 3B depicts an example control plane protocol stack for L2 WTRU-to-Network relay. An SRAP sublayer may be placed above an RLC sublayer for both CP and UP at (e.g., both) PC5 interface and/or Uu interface. A Uu SDAP, PDCP and RRC may be terminated between L2 U2N Remote WTRU and gNB. SRAP, RLC, MAC and PHY may be terminated in a (e.g., each) hop (e.g., a link between L2 U2N Remote WTRU and L2 U2N Relay WTRU and a link between L2 U2N Relay WTRU and a gNB).

For L2 U2N Relay, a SRAP sublayer over PC5 hop may be for the purpose of bearer mapping. A SRAP sublayer may not be present over PC5 hop (e.g., for relaying the L2 U2N Remote WTRU's message on BCCH and PCCH). For L2 U2N Remote WTRU's message on SRB0, the SRAP sublayer may not be present over PC5 hop. A SRAP sublayer may be present over Uu hop for both DL and UL.

For L2 U2N Relay, for uplink, a Uu SRAP sublayer may support UL bearer mapping between ingress PC5 Relay RLC channels for relaying and egress Uu Relay RLC channels over a L2 U2N Relay WTRU Uu interface. For uplink relaying traffic, different end-to-end RBs (SRBs or DRBs) of the same Remote WTRU and/or different Remote WTRUs may be multiplexed over the same Uu Relay RLC channel.

For L2 U2N Relay, for uplink, a Uu SRAP sublayer may support L2 U2N Remote WTRU identification for UL traffic. Identity information of L2 U2N Remote WTRU Uu Radio Bearer and a local Remote WTRU ID may be included in a Uu SRAP header at UL (e.g., in order for gNB to correlate received packets for a (e.g., specific) PDCP entity associated with the right Uu Radio Bearer of a Remote WTRU).

For L2 U2N Relay, for uplink, a PC5 SRAP sublayer at the L2 U2N Remote WTRU may support UL bearer mapping between Remote WTRU Uu Radio Bearers and egress PC5 Relay RLC channels.

For L2 U2N Relay, for downlink, a Uu SRAP sublayer may support DL bearer mapping at gNB to map end-to-end Radio Bearer (SRB, DRB) of Remote WTRU into Uu Relay RLC channel over a Relay WTRU Uu interface. A Uu SRAP sublayer may support DL bearer mapping and data multiplexing between multiple end-to-end Radio Bearers (SRBs or DRBs) of a L2 U2N Remote WTRU and/or different L2 U2N Remote WTRUs and a (e.g., one) Uu Relay RLC channel over a Relay WTRU Uu interface.

For L2 U2N Relay, for downlink, a Uu SRAP sublayer may support Remote WTRU identification for DL traffic. Identity information of Remote WTRU Uu Radio Bearer and a local Remote WTRU ID may be included into a Uu SRAP header by a gNB at DL (e.g., in order for Relay WTRU to map received packets from Remote WTRU Uu Radio Bearer to the Relay WTRU's associated PC5 Relay RLC channel).

For L2 U2N Relay, for downlink, a PC5 SRAP sublayer at a Relay WTRU may support DL bearer mapping between ingress Uu Relay RLC channels and/or egress PC5 Relay RLC channels.

For L2 U2N Relay, for downlink, a PC5 SRAP sublayer at a Remote WTRU may correlate received packets for a (e.g., specific) PDCP entity associated with the right Uu Radio Bearer of a Remote WTRU (e.g., based on the identity information included in the Uu SRAP header).

A local Remote WTRU ID may be included in (e.g., both) a PC5 SRAP header and/or a Uu SRAP header. L2 U2N Relay WTRU may be configured by a gNB with a local Remote WTRU ID to be used in a SRAP header. A remote WTRU may obtain a local Remote ID from a gNB via Uu RRC messages including RRCSetup, RRCReconfiguration, RRCResume and/or RRCReestablishment. Uu DRB(s) and/or Uu SRB(s) may be mapped to different PC5 Relay RLC channels and/or Uu Relay RLC channels in (e.g., both) PC5 hop and/or Uu hop.

It may be the responsibility of a gNB to avoid collision on the usage of local Remote WTRU ID. A gNB may update a local Remote WTRU ID (e.g., by sending an updated local Remote ID via RRCReconfiguration message to a Relay WTRU). A serving gNB may perform local Remote WTRU ID update(s) independent of the PC5 unicast link L2 ID update procedure.

Feature(s) associated with sidelink scheduling are provided herein.

Sidelink may support scheduling mode(s) (e.g., two scheduling modes, mode 1 and/or mode 2). For an in-coverage WTRU, a gNB may control whether a WTRU may transmit using a particular mode (e.g., mode 1 or mode 2).

In mode 1 scheduling (e.g., which may be used for a sidelink WTRU (e.g., in RRC_CONNECTED)), a WTRU may receive SL grants from (e.g., directly from) a network in DCI. A WTRU may report a buffer status for SL data grouped by a destination index (e.g., where a destination index corresponds to a unique destination, such as a L2 destination ID, and/or a pair of source/destination (e.g., source/destination L2 ID)). A WTRU may report SL SR if a SL grant is not available for transmission of pending data.

In mode 2 scheduling (e.g., which may be used by a WTRU (e.g., in any RRC state), or a WTRU which is out of coverage), a WTRU may be configured with a resource pool from which the WTRU may perform autonomous resource selection and/or scheduling. Resources may be selected by a WTRU based on information in previous SCI transmissions by other WTRUs (e.g., sensing results).

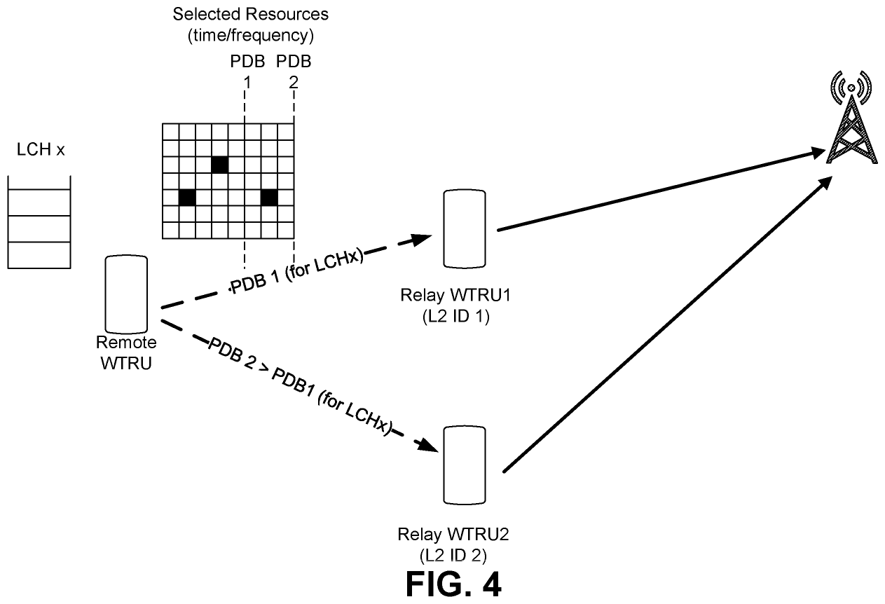

For multipath consisting of two SL relay paths, the SL paths may be on the same carrier but be via two different paths, nodes or relays (e.g., different L2 destination IDs). FIG. 4 depicts an example LCH that may take different paths. Approaches to provide for a procedure (e.g., MAC/PHY layer procedure) for the network to control the path when a single LCH or data flow can take different paths (e.g., via different destinations) may be needed. The network may configure a PDB on the SL hop (e.g., based on the Uu conditions) but that PDB may be different for different paths, e.g., when the relays are connected to different cells/gNBs. If resource selection is performed based on the PDB of one relay, the PDB of one relay may be inadequate for transmission to the other relay (e.g., even though both relays may be used to successfully transmit the data to the network). Thus, problems may be associated with when one of the relays has issues and the resources were selected based on the PDB associated with that relay. For the case of mode 1, if the network allocates data based on an assumption of transmission to a first relay, the network should be informed in case of a problem with that relay, but relying on RRC signaling may be too slow to adjust the scheduling decisions (e.g., quickly).

The network may be aware that the WTRU should transmit data over a particular relay (e.g., when one relay is no longer preferred).

There may be a need for destination selection where the same data can be transmitted to multiple destinations. One issue that may arise during transmission (e.g., if the WTRU is allowed to select the destination) is that the WTRU continually selects the same destination for the transmission of data, which may result in unequal congestion for the relays. Feature(s) associated with addressing the aforementioned issues are provided herein.

Systems, methods, devices, and instrumentalities described herein may be related to resource selection for multiple destinations.

A device (e.g., a wireless transmit/receive unit (WTRU)) may include a processor configured to perform one or more actions. The device may receive an indication from a first node or relay WTRU that that indicates a first packet delay budget (PDB) and an indication from a second node or relay WTRU that that indicates a second PDB. The device may determine that there is data to be sent. The device may perform resource selection that includes determining a resource selection window.

The second PDB may be larger than the first PDB. The device may receive an indication of congestion from the second relay WTRU. The determination of the resource selection window may be based on the indication of congestion from the second relay WTRU and the second PDB being larger than the first PDB. The device may determine the resource selection window is a minimum PDB between the first PDB and the second PDB.

The device may determine that a channel busy ratio meets or is greater than a threshold. The determination of the resource selection window may be based at least on the channel busy ratio meeting or being greater than the threshold. The device may, based at least on the channel busy ratio meeting or being greater than the threshold, determine the resource selection window is a maximum PDB from the first PDB and the second PDB. The determination that the resource selection window is a maximum PDB from the first PDB and the second PDB by the device may further be based on not having received an indication of congestion from a relay WTRU with a largest PDB.

The device may determine that a grant has a logical channel prioritization restriction associated with the destination if a selected resource occurs after a PDB associated with a destination.

Systems, methods, devices, and instrumentalities are described herein related to destination selection for different destinations.

A device (e.g., a wireless transmit/receive unit (WTRU) may include a processor configured to perform one or more actions. The device may determine that there is data to be sent on a logical channel. The logical channel may be associated with a first destination and a second destination. The device may determine a destination. The device may select the destination.

The device may receive information. The information may indicate a first prohibit time associated with the first destination and a second prohibit time associated with the second destination. The device determine that the first destination was selected for a previous transmission on the logical channel within the first prohibit time. The determination of the destination may be based on the first destination being selected for a previous transmission within the first prohibit time. The device may determine the destination to be the second relay WTRU.

The determination of the destination may be based on based on a determination that a time since the first relay WTRU was last selected as the destination is less than a time since the second relay WTRU was last selected as the destination. The device may determine the destination to be the second relay WTRU.

The device may receive a first destination scheduling pattern and a second destination scheduling pattern. The first destination scheduling pattern may be associated with a first flow control level and the second destination scheduling pattern may be associated with a second flow control level. The device may receive a first flow control message that may be associated with a first relay and a second flow control message level that may be associated with a second relay. The first relay may be associated with the first destination and the second relay may be associated with the second destination. The device may determine a destination scheduling pattern based on the first flow control message and the second flow control message. The determination of the destination may be based on the destination scheduling pattern.

The device may perform logical channel prioritization, wherein the logical channel prioritization comprises a determination that the logical channel has a highest priority.

Systems, methods, devices, and instrumentalities are described herein related to BSR trigger(s) for advanced multipath.

A device (e.g., a wireless transmit/receive unit (WTRU)) may include a processor configured to perform one or more actions. The device may determine a first amount of data associated with a first destination and a second amount of data associated with a second destination. The device may receive an indication from the first destination. The device may determine, based on the indication, an updated amount of data associated with the second destination. the updated amount of data may be the first amount of data or the first amount of data combined with the second amount of data.

The device may send a report (e.g., to a network) indicating the updated amount of data associated with the second destination. The report may be sent to a base station. The indication from the first destination may be a failure indication. The report may be a buffer status report.

The first destination may be a first relay WTRU and the second destination may be a second relay WTRU.

Systems, methods, devices, and instrumentalities are described herein related to resource (re)selection trigger(s) for multipath.

A device (e.g., a wireless transmit/receive unit (WTRU)) may include a processor configured to perform one or more actions. The device may determine a first packet delay budget (PDB) associated with a first destination and a second PDB associated with a second destination. The first PDB and the second PDB may have different values. The device may perform resource selection. The device may receive a failure indication associated with the first destination. The device may perform resource reselection based on the reception of the failure indication and the first PDB and the second PDB having different values.

The failure indication may indicate a failure of a path. The resource reselection may be a reselection for a resource selected in the performed resource selection. The device may send data via a valid path using a resource from the performed resource reselection.

The first destination may be a first relay WTRU and the second destination may a second relay WTRU.

Feature(s) associated with resource selection for multiple destinations (e.g., relay WTRUs) are provided herein.

In examples, one or more of the following may be performed. A remote WTRU may determine a resource selection window to send (e.g., transmit) to relay WTRU(s). The remote WTRU may determine a resource selection window (e.g., in indirect) based on indications (e.g., flow control indications) provided by the relay WTRUs and/or a measured channel busy ratio (CBR). The remote WTRU may be configured with multiple (e.g., two) destinations (e.g., L2 destinations) usable for a SL-LCH (e.g., multiple paths via different relays), having respectively a first PDB for the first destination (e.g., first relay), and a second PDB for a second destination (e.g., second relay). Resource selection at the remote WTRU may be triggered, e.g., by the arrival of data. The resource selection may comprise or be associated with determining the resource selection window.

A remote WTRU may determine a resource selection window by performing one or more of the following. If congestion is indicated by a destination (e.g., relay) with a larger PDB (e.g., a larger PDB of the multiple destinations) the WTRU may determine the resource selection window by selecting the minimum PDB configured for each of the destinations (e.g., relays). If congestion is not indicated by a destination (e.g., relay) with a larger PDB and if the CBR is greater than a threshold (e.g., satisfies a threshold, is greater than or equal to a threshold, etc.), the WTRU may determine the resource selection window by selecting the maximum PDB configured between each of the destinations (e.g., relays). The WTRU may (e.g., otherwise) use either a minimum or a maximum resource selection window (e.g., if congestion is not indicated by a destination (e.g., relay) with a larger PDB and if the CBR is not greater than the threshold).

If a selected resource occurs after the PDB of one of the destinations (e.g., L2 destinations) a WTRU may identify a grant as having a logical channel prioritization (LCP) restriction for the SL-LCH associated with that destination.

When selecting data to include in a grant (e.g., in a granted resource) for the SL-LCH, a WTRU may select a destination with a smaller configured PDB if the grant was identified with a LCP restriction. In examples, a WTRU may (e.g., otherwise) select any destination. A WTRU may send (e.g., transmit) data for the SL-LCH to a selected destination. A destination ID may be sent (e.g., indicated in the transmission).

Feature(s) associated with configuring a WTRU with multiple PDB are provided herein (e.g., for a specific LCH).

PDB may be used by a sidelink WTRU to perform resource selection. The WTRU may be configured (e.g., per logical channel) with a PDB, and may perform resource selection such that the selection window corresponds to the configured PDB.

The WTRU (e.g., remote WTRU) may determine and/or be configured with multiple PDBs for a specific LCH. Each PDB may or may be associated with one or more of the following: transmission to different relay WTRUs (e.g., a first PDB associated with a first relay WTRU; a second PDB associated with a second relay WTRU; etc.); correspond to different information provided by a relay WTRU; a number of hops over the end-to-end path; a type of data; or a carrier (e.g., on Uu or SL).

A PDB may be associated with transmission to different relay WTRUs. For example, if a WTRU performs transmission involving resource selection to a first destination (e.g., first relay WTRU), the WTRU may use the first PDB, and if the WTRU performs transmission involving resource selection to a second destination (e.g., second relay WTRU), the WTRU may use the second PDB.

A PDB may correspond to different information provided by a relay WTRU. A remote WTRU may receive information (e.g., indication, selection, configuration) from a relay WTRU that may inform the remote WTRU of which PDB to apply, either explicitly (e.g., with a selection of the PDB) or implicitly (e.g., by providing other configuration and/or status information that may impact the selection of PDB by the remote WTRU). For example, the relay WTRU may provide different flow control quantities to the remote WTRU, and the remote WTRU may select the PDB associated with each configured flow control quantity. For example, the relay WTRU may provide an assumed latency (e.g., on the next hop) to the remote WTRU, and the remote WTRU may select the appropriate PDB (e.g., for the associated next hop latency and/or PBD). For example, the relay WTRU may provide measurements (e.g., of the next hop) to the remote WTRU, and the remote WTRU may select a configured PDB associated with the provided measurements. In examples, the relay WTRU may provide the relay WTRU's RRC state to the transmitting remote WTRU, which may select a PDB based on the provided RRC state. In examples, the relay WTRU may provide its connectivity with Uu to the remote WTRU (e.g., an RRC state of the WTRU with the network, a number of subsequent relay WTRUs until the destination, the existence of a connection, the latency of the subsequent hops, and/or the like), and the remote WTRU may select a PDB based on the provided connectivity information.

A PDB may correspond to a number of hops over the end-to-end path. For example, a WTRU may be configured with a number of hops associated with the end-to-end link (e.g., U2N or U2U) and may be configured with a PDB to use for the number of hops. For example, a WTRU may receive a remaining number of hops from a relay WTRU, and the WTRU may select one of a number of configured PDBs based on the remaining number of hops.

A PDB may correspond to a type of data. For example, a WTRU may use a different PDB for different types of data being transmitted on the same LCH (e.g., PDU set type).

A PDB may correspond to a carrier (e.g., Uu or SL). For example, a WTRU may use a different PDB for different carriers and/or carrier types (e.g., unlicensed vs licensed). For example, a WTRU may receive an association between a PDB and a carrier (e.g., from a network or from a relay WTRU).

Each PDB may be associated with one or more relay WTRUs. The relay WTRU(s) associated with each PDB may be used as a transmission path for a LCH. For example, a WTRU may be configured with a LCH that may have two different relays as potential SL transmission paths. Each relay may serve as a different path for the end-to-end data to take to a final destination node (e.g., the network, or a peer WTRU).

The WTRU may receive multiple PDB values and associated relay WTRU ID(s) from the network (e.g., in RRC signaling). In examples, the WTRU may receive multiple pairs of PDB and relay WTRU ID (e.g., may receive a first PDB associated with a first relay WTRU; a second PDB associated with a second relay WTRU; etc.).

The WTRU may receive multiple PDB values from the network (e.g., in an RRC message) and may determine an association of a PDB with a corresponding relay (e.g., based on an explicit indication in the RRC message, based on a specified rule, etc.).

The order of the PDB values received in an RRC message may correspond to an order of WTRU ID (e.g., lowest to highest relay WTRU ID or highest to lowest relay WTRU ID). For example, a first PDB value configured by the network may be associated with a relay WTRU with the lowest WTRU ID, the next PDB value configured by the network may be associated with a relay WTRU with the next lowest WTRU ID, and so on.

The order of the PDB values received in an RRC message may correspond to an order of relay WTRU IDs reported by a remote WTRU to the network. For example, a first PDB value may be associated with a first relay WTRU ID reported by the remote WTRU to the network, a second PDB value may be associated with a second relay WTRU ID reported by the remote WTRU to the network, and so on.

The order of the PDB values received in an RRC message may correspond to the order in which the WTRU initiated a unicast connection with the corresponding relay.

The WTRU may derive one PDB value (e.g., for one relay) from another PDB value (e.g., for another relay). For example, a WTRU may be configured with a first PDB value. The WTRU may be configured to associate the first PDB value to a specific relay WTRU. The WTRU may then determine other PDB value(s) based on the first PDB value.

The WTRU may determine a PDB value (e.g., a PDB value to use) based on one or more of the following: SL measurements, information received from a relay WTRU, a period of time following an event, a network indication, or an amount of data available for transmission.

SL measurements may be used by a WTRU to determine a PDB value. For example, a WTRU may add an amount to a configured first PDB when SL measurements associated with another relay WTRU are below a configured threshold (e.g., a WTRU may add an amount to a configured first PDB associated with a first WTRU when SL measurement(s) associated with another relay WTRU (e.g., a second WTRU) are below a configured threshold). For example, a WTRU may be configured with different PDB values, where each PDB value may be used for a configured range of measured SL RSRP, SL CBR, SL CQI, and the like.

Information received from a relay WTRU may be used by a WTRU to determine a PDB value. A remote WTRU may receive flow control indications from a relay WTRU and may determine a PDB based on the received flow control indications. A remote WTRU may use a first PDB if flow control indication(s) (e.g., received from a relay WTRU) correspond to (e.g. indicate) congestion (e.g., at the relay WTRU), and may use a second PDB when flow control indication(s) (e.g., received from a relay WTRU) correspond to (e.g., indicate) no congestion (e.g., at the relay WTRU). A remote WTRU may receive Uu measurements (e.g., RSRP) of a backhaul link and may determine a PDB based on the received Uu measurements. A remote WTRU may use a first PDB if received Uu measurements are in a first range and may use a second PDB if received Uu measurements are in a second range. A remote WTRU may receive an indication from a relay WTRU related to an event at the relay (e.g., Uu radio link failure (RLF), Uu re-establishment completed following RLF, handover (HO) or reselection at the relay WTRU, RRC connection failure, and the like), and the remote WTRU may change from a first PDB to a second PDB after receiving the indication. A remote WTRU may receive information from a relay WTRU indicating a number of hops associated with a relay path. The remote WTRU may determine the PDB to use based on the number of hops and/or a change in the number of hops. A remote WTRU may receive an indication from a relay WTRU to change the PDB to use (e.g., an explicit indication of a PDB to use for the relay WTRU).

A period of time following an event may be used by a WTRU to determine a PDB value. For example, a remote WTRU may change from a first PDB to a second PDB following an event (e.g., reception of an indication from the relay WTRU). The remote WTRU may use the second PDB for a period of time following this event (e.g., before changing to the first PDB).

A network indication may be used by a WTRU to determine a PDB value. For example, a remote WTRU may receive an indication (e.g., in a MAC CE, RRC message, or DCI) and may change from one PDB to another PDB after receiving the indication. The indication from the network may further select (e.g., indicate), for example explicitly or implicitly, the PDB to use.

An amount of data available for transmission may be used by a WTRU to determine a PDB value. For example, a remote WTRU may use a first PDB when an amount of data available for transmission (e.g., for a LCH or a relay WTRU), is below a threshold, and may use a second PDB otherwise.

Feature(s) associated with a WTRU determining which PBD to apply during resource selection are provided herein.

The WTRU may perform resource selection based on data associated with a LCH. The WTRU may be allowed to transmit data via two or more different paths (e.g., in some scenarios related to multipath) and each path may be associated with a respective PDB (e.g., each path has a different PDB). A path (e.g., as used herein) may correspond to (e.g., include) one or more of a source L2 ID, a destination L2 ID, a local ID, a C-RNTI, or any other ID that identifies another WTRU (e.g., a relay WTRU) or a path to a destination WTRU.

A WTRU may use a single (e.g., selected) PDB for resource selection that may be derived (e.g., determined) from PDBs associated with each path. A WTRU's selected PDB may further depend on one or more of the following factors.

The WTRU may select the minimum PDB of the PDBs configured for each path, the maximum PDB of the PDBs configured for each path, or the average PDB of the PDBs configured for each path. In considering the PDBs configured for each path (e.g., the minimum PDB, the maximum PDB, or the average PDB) the WTRU may consider the paths that are allowed for the LCH (e.g., only consider the paths that are allowed for the LCH). The WTRU may select (e.g., may select based on one or more of the following): the most common PDB (e.g., the PDB that has the largest number of paths with that PDB value); the PDB such that at least or at most N or M% of the paths have a PDB less than or greater than that PDB; the PDB for which at least or at most N or M% of the paths are allowable transmission paths (e.g., paths that are allowable because the selected PDB, and therefore the resources selected, will meet the PDB associated with that path); a configured value, or a fixed value (e.g., that may not be related to the PDB associated with each path).

A WTRU may select a PDB (e.g., one of the respective PDBs or a PDB associated with one of the respective PDBs) based on one or more of the following factors: QoS of the data or LCH; measurements of the congestion and/or usage of the sidelink resources (e.g., CBR, CR, RSSI, and the like); duplication configuration of the bearer corresponding to the LCH; number of paths over which the data associated with the LCH is being duplicated; measurements of Uu and/or a Uu path (e.g., any Uu path); amount of data in the buffer(s); size of a resource selected or to be selected; available resources; an indication from the relay WTRU(s) and/or a condition derived from such indications (e.g., if the indication comes from the path associated with the minimum/maximum PDB, or a path where the PDB meets a condition(s)); a measurement of a link with a relay WTRU on one or more of the path(s) (e.g., SL RSRP, SD RSRP, SL CSI, and the like); presence and/or information related to IUC information received from the relay (e.g., sensing results received from the one or more relay WTRUs associated with the different paths); determination of an error on a path by a transmitting WTRU (e.g., SL RLF, LBT failure, and the like); randomly; or based on some percentage number of selection. The percentage may depend on one or more factors.

Factors used to select a PDB may be based on one or more of the following: selecting a PDB associated with the shortest, or a shorter, PDB may guarantee that the data may take any path to the destination while ensuring quality of service (QOS) is met; selecting a PDB associated with the longest, or a longer, PDB may ensure that the WTRU can select from a larger number of resources; or the WTRU may, if it determines that transmission via a path cannot happen, or should happen less often (e.g., due to problems with that path), favor transmissions on other paths, and should therefore tailor a window for resource selection to that other path.

A WTRU may select a PDB based on QoS of the data or LCH. In examples, the WTRU may be configured per LCH and/or SLRB (e.g., whether to select the minimum or maximum PDB among the paths for resource selection associated with that LCH and/or SLRB). In examples, the WTRU may be configured with a threshold priority, above which, the WTRU may select the maximum PDB or minimum PDB, and below which, the WTRU may select the minimum PDB or maximum PDB.

A WTRU may select a PDB based on measurement(s) (e.g., indication) of the congestion and/or usage of the sidelink resources (e.g., CBR, CR, RSSI, and the like). For example, the WTRU may select the maximum PDB when the CBR is above a threshold.

A WTRU may select a PDB based on a duplication configuration of the bearer corresponding to the LCH, or a number of paths over which the data associated with the LCH is being duplicated. For example, if the WTRU is configured with duplication for the LCH, the WTRU may select the maximum PDB.

A WTRU may select a PDB based on measurements of Uu or any Uu path (e.g., any path that may be an alternative for the transmission associated with multipath and/or that may impact the transmission parameters associated with the sidelink/relayed path). For example, if the Uu RSRP is below a threshold, the WTRU may select the minimum PDB for resource selection.

A WTRU may select a PDB based on an amount of data in the buffer(s). For example, if the buffer occupancy is above a threshold, the WTRU may select the maximum PDB.

A WTRU may select a PDB based on a size of the resource selected or to be selected. For example, if the size of the resource(s) (e.g., number of subchannels) is above a threshold, the WTRU may select the maximum PDB.

A WTRU may select a PDB based on available resources. In examples, available resources may be determined as a measure of resources associated with a percentage or absolute amount and/or a metric derived from resource selection procedure. For example, if a percentage of available resources is above a threshold, the WTRU may select the minimum PDB.

A WTRU may select a PDB based on an indication from a relay WTRU(s), or any condition derived from such indications (e.g., whether the indication comes from (e.g., corresponds to) the path associated with the minimum/maximum PDB, or a path where the PDB meets a condition(s)). An indication from a relay WRTU and/or a condition from such an indication may correspond to one or more of: error conditions (e.g., those sent in NotificationSidelinkMessage, such as relay HO, Uu RLF, and the like); flow control measurement and/or indication; measurement on the next hop (e.g. SL or Uu RSRP); estimated latency on a path, (e.g., provided by the relay WTRU); or RRC state (e.g., of the relay WTRU, or any relay WTRU along the path of transmission).

Error condition(s) (e.g., from a relay WTRU) may be used by a WTRU to select a PDB. Error conditions may include condition(s) such as those sent in NotificationSidelinkMessage (e.g., relay HO, Uu RLF, and the like). The WTRU may exclude a PDB associated with a link which is failed (e.g., Uu RLF has occurred and recovery is yet to be confirmed). The WTRU may exclude the PDB for the period of time in which the failure persists. The WTRU may set the PDB associated with a path to a different value upon reception of an error indication from the relay WTRU associated with that path. For example, the WTRU may select the minimum PDB if at least X paths have an error condition.

Flow control measurement(s) and/or indication(s) (e.g., from a relay WTRU) may be used by a WTRU to select a PDB. For example, if a flow control measurement received from a path is above a threshold, the WTRU may exclude the PDB associated with that path as a potential path PDB in selection of the PDB used for resource selection. For example, if a relay WTRU on a path associated with the maximum PDB (e.g., largest PDB) indicates a flow control issue (e.g., congestion), the WTRU may select the minimum PDB or a shorter PDB.

Measurement on the next hop (e.g., SL or Uu RSRP from a relay WTRU) may be used by a WTRU to select a PDB. For example, if a measurement (e.g., RSRP) associated with the next hop provided by a relay WTRU is below a threshold and the relay WTRU itself is associated with the minimum PDB, the WTRU may select the maximum PDB.

Estimated latency on a path (e.g., provided by the relay WTRU) may be used by a WTRU to select a PDB.

An RRC state (e.g., of a relay WTRU, or any relay WTRU along the path of transmission) may be used by a WTRU to select a PDB. For example, the RRC state of one of the relay WTRUs may be RRC_IDLE/RRC_INACTIVE and the WTRU may exclude the PDB associated with that path as a potential path for selection of the PDB used for resource selection.

The WTRU may select a PDB based on measurement of the link with a relay WTRU on the path(s) (e.g., SL RSRP, SD RSRP, SL CSI, and the like).

The WTRU may select a PDB based on a presence of and/or information related to Inter UE Coordination (IUC) information received from the relay (e.g., sensing results received from the one or more relay WTRUs associated with the different paths).

The WTRU may select a PDB based on determination of an error on the path by the transmitting WTRU (e.g., SL RLF, LBT failure, and the like).

The WTRU may select a PDB randomly or based on a percentage number of selection where the percentage may further depend on one or more of the aforementioned factors. The WTRU may randomly select a PDB between the minimum and maximum PDB. The WTRU may select a PDB with a (pre)configured probability, a (pre)configured frequency of occurrence, the minimum PBD, or the maximum PBD. The probability or frequency of occurrence may be determined based on the relative measurements of each link (e.g., measured by the remote WTRU, or informed by the relay WTRU associated with that link).

If there are two potential paths that correspond to relaying paths, the WTRU may select a resource selection window where the PDB associated with such resource selection window may be derived from a PDB associated with each path and/or the window selection may depend on one or more of the aforementioned factors at the time of resource selection.

The WTRU may select the maximum PDB based on one or more of flow control indications or CBR. For example, the WTRU may select the minimum PDB if a flow control problem (e.g., congestion) is indicated from the relay WTRU associated with the path with the larger PDB. The WTRU may select the maximum PDB if no flow control problem is indicated and/or if the CBR is above a threshold. In examples, (e.g., if congestion is not indicated by a destination (e.g., relay) with a larger PDB and if the CBR is not greater than the threshold) the WTRU may select either the minimum PDB or the maximum PDB, or may select between the minimum and maximum PDB with some (pre)configured or (pre)determined probability.

Feature(s) associated with selection of a resource (e.g., by the MAC layer) are provided herein. Selection of a resource by the MAC layer may be impacted by having multiple paths with different PDBs.

A WTRU may select a resource for transmission from a set of available resources based on a difference in the PDB associated to each path. Example selection may comprise one or more of: selecting from the available resources with equal probability; selecting from the available resources with equal probability after excluding a subset of available resources; or selecting from the available resources corresponding to the minimum PDB with a specific probability or frequency of selection (e.g., only with a specific probability or frequency of selection) .

The WTRU may select a resource for transmission from the available resources with equal probability. The WTRU may use this approach based on one or more conditions described herein (e.g., a condition associated with PDB selection). The WTRU may use this approach based on whether a used resource selection window corresponds to a minimum PDB or a maximum PDB. For example, if the resource selection window corresponds to the minimum PDB, the WTRU may select from the available resources with equal probability (e.g., because the resources may be used to transmit on each of the relaying paths).

The WTRU may select a resource for transmission from the available resources with equal probability after excluding a subset of available resources. The WTRU may select from the available resources considering the resources (e.g., only the resources) within the window of the minimum PDB (and, for example, excluding the resources that are available which fall between the minimum PDB and the resource selection window). The WTRU may be restricted to select an available resource that would meet the PDB associated with the minimum PDB. The WTRU may use this approach based on one or more conditions described herein (e.g., a condition associated with PDB selection). For example, if the path associated with larger PDB is unavailable, the WTRU may select from the resources associated with the smaller PDB (e.g., from the resources associated only with the smaller PDB).

The WTRU may select a resource for transmission from the available resources corresponding to the minimum PDB with a specific probability or frequency of selection. The WTRU may use this approach based on one or more conditions described herein (e.g., a condition associated with PDB selection). The frequency or probability may depend on one or more conditions described herein (e.g., a condition associated with PDB selection).

Feature(s) associated with destination selection in LCP are provided herein. Destination selection in LCP may depend on the timing of a selected grant compared to each PDB.

A WTRU may select a destination for transmission in a grant based on the timing of that grant relative to the associated PDB for each destination. The destination may be associated with a path. For example, each destination may correspond to a relay WTRU. For example, data from a LCH can be transmitted to either destination due to availability of multiple paths. For example, each path may be configured with a different PDB to be respected for transmission of data from the LCH via that path (e.g., in order for QoS to be met for that data).

The WTRU may restrict selection of a destination for transmission of data based on whether a resource meets the PDB of the data associated with that path. For example, if the resource is located within the PDB of both the first destination and the second destination, the WTRU may select either destination. If the grant (e.g., resource(s) associated with the grant) is located within the PDB associated with a subset of the destinations (e.g., only a subset of the destinations), the WTRU may restrict selection of the destinations to one of the subset of destinations.

A WTRU may determine (e.g., further determine) whether to impose a restriction on a grant located outside the PDB associated with a destination based on one or more of: the QoS of the data; whether the logical channel is associated with data being duplicated over another LCH; an indication from the corresponding relay WTRU; or one or more conditions described herein (e.g., associated with PDB selection during resource selection).

The WTRU may determine whether to impose a restriction on a grant located outside the PDB associated with a destination based on the QoS of the data. In examples, the WTRU may be configured with bearers or SL LCHs that allow destination selection such that the selected resource occurs after the PDB associated with the destination. For example, if the priority of the data is below a threshold, the WTRU may allow destination selection such that selected resource occurs after the PDB associated with the destination.

A WTRU may determine whether to impose a restriction on a grant located outside the PDB associated with a destination based on whether a LCH is associated with data being duplicated over another LCH. For example, if the LCH is associated with duplication of the same data over another LCH, the WTRU may select a destination without imposing a restriction on whether the resource occurs within the PDB associated with the destination. If duplication is not configured, the WTRU may select (e.g., only select) the destination(s) where the resource occurs prior to the PDB.

A WTRU may determine whether to impose a restriction on a grant located outside the PDB associated with a destination based on an indication from a corresponding relay WTRU. The indication from the corresponding relay WTRU may comprise one or more of: measurements of the next hop; resource allocation mode associated with the next hop; RRC state (e.g., of the relay WTRU); or similar condition(s) described herein (e.g., for PDB selection during resource selection). For example, if the measurements of the next hop (e.g., indicated by the relay WTRU) are above a threshold, the remote WTRU may select any destination (e.g., a destination where the resource occurs after the configured PDB). For example, if the next hop uses mode 1, the remote WTRU may select any destination (e.g., a destination where the resource occurs after the configured PDB). For example, if the relay WTRU associated with a destination is in RRC_CONNECTED, the WTRU may be allowed to select any destination (e.g., a destination where the resource occurs after the configured PDB).

Feature(s) associated with destination selection (e.g., between different destinations associated to a single LCH) are provided herein.

A remote WTRU may select one of multiple destinations configured for a SL LCH based on previous destinations selected for transmission of the same and/or similar LCH and/or a time since the destination was last selected.

One or more of the following may be performed by a remote WTRU (e.g., associated with destination selection). The remote WTRU may be configured with more than one destination (e.g., L2 destinations) usable for a SL LCH. The remote WTRU may be configured for multiple paths via different relays (e.g., via relay WTRUs). The WTRU may be configured with a prohibit time associated with each destination (e.g., L2 destination). The WTRU may perform SL LCP associated with a SL grant. In examples, if a LCH with a highest priority has data available for transmission and is associated with multiple destinations (e.g., L2 destinations), and one of the destinations was already selected in the past within a prohibit time, the remote WTRU may select the other destination (e.g., the WTRU may be prohibited from selecting destination(s) that were selected in the past within the prohibit time). The remote WTRU may (e.g., otherwise) select either of the destinations (e.g., with equal probability). The remote WTRU may transmit data to a selected destination. The remote WTRU may include a destination ID in the transmission.

The WTRU may select a destination (e.g., one of multiple destinations) allowable for a grant. A WTRU may be configured with rules, and/or condition(s) when selecting a destination for transmission of data in a grant (e.g., in a granted resource), for example if multiple destinations are associated with a single logical channel. Selection rules, and/or conditions configured for a WTRU may be used in situations where the logical channels associated with the destinations are different.

The WTRU may be configured with (e.g., receive information that indicates) a list of destinations corresponding to different relay WTRUs that may be associated with different paths to the same end destination (e.g., a base station). The WTRU may be configured to determine which destinations are related (e.g., which destinations (e.g., relay WTRUs) are associated with different paths to the same end destination). Applying selection condition(s) may more evenly (e.g., equally) distribute transmissions to the different paths to avoid congestion of one path over another (e.g., when both paths are associated with the same end destination).

The WTRU may use one or more of the following condition(s) when selecting a destination: proportion or probability (e.g., a (pre)determined or (pre)configured probability); time from the last selection of a destination; number of selections within a period of time; measurements associated with a specific destination; an indication (e.g., from a relay WTRU) associated with the destination; or priority of data (e.g., data to be transmitted).

A WTRU may select a destination based on a proportion or probability. For example, a WTRU may be configured with a (pre)determined or (pre)configured probability for the selection of a (e.g., one) destination within a group of related destinations. For example, the probability may depend on (e.g., other) factor(s) (e.g., those described herein). For example, a WTRU may be configured to maintain a (pre)determined or (pre)configured proportion for destination selection (e.g., over a period of time the WTRU may select a destination 20% of the time). For example, the proportion may depend on (e.g., other) factor(s) (e.g., those described herein).

The WTRU may select a destination based on a time from a last selection of that destination. The time from the last selection of a destination may be described in terms of number of sidelink slots. For example, a WTRU may be configured with a prohibit timer associated with selection of a destination.

Following selection of a first destination for transmission of data associated with a LCH, the WTRU may (e.g., only) select the same first destination for a subsequent transmission (e.g., of the same LCH), after a period of time associated with the prohibit timer may have elapsed.

The WTRU may select a destination based on a number of selections within a period of time. The number of selections within a period of time may be consecutive selections. For example, the number of selections may be associated with a specific LCH or QoS flow. For example, a WTRU may be configured with a maximum (N) number of consecutive selections of the same destination. If the WTRU selects the same destination N consecutive times, the WTRU may then select another destination in a subsequent (M) number of SL grants (e.g., where N and M may be configured). For example, a WTRU may be configured with a maximum (N) number of resource selections performed (e.g., related to a group of related destinations). If the WTRU selects the same destination each time and a destination in the group is selected a number N consecutive times, the WTRU may select another destination in a subsequent (M) number of SL grants (e.g., where a destination in the group is selected).

The WTRU may select a destination based on measurements associated with a specific destination or group of destinations. Measurements associated with a specific destination or group of destinations may comprise one or more of SL-RSRP, SD-RSRP, SL CQI, SL CBR, and/or the like. For example, a WTRU may select the destination having the largest measured SL-RSRP at the time of the grant. For example, a WTRU may select destination(s) associated with a group of destinations (e.g., in proportion to (e.g., which is directly related to) the measured SL-RSRP of each of the destination(s). For example, if a first destination is N times better than a second destination, the WTRU may select the first destination N times more frequently than the second destination. For example, a WTRU may select destinations in an equal proportion (e.g., with equal probability), e.g., as long as the (e.g., each) destinations have a measurement above a threshold (e.g., a first destination is selected as frequently as a second destination). For example, a WTRU may select destinations in an equal proportion (e.g., with equal probability) if none of the destinations have measurements above a threshold. If a destination is below a measurement threshold, the WTRU may select a better destination (e.g., in terms of measurements) with a higher proportion (e.g., higher probability, higher frequency). For example, a WTRU may exclude the selection of a destination if the destination has a measurement below a threshold.

The WTRU may select a destination based on an indication (e.g., an indication from a relay associated with the destination). An indication may be one or more of: error indication(s), flow control indications, congestion indications, or RCC state(s).

The WTRU may select a destination based on an error indication. For example, a remote WTRU may receive an indication (e.g., from a relay WTRU) of a HO, Uu RLF, next hop RLF, connection establishment failure, and/or the like. The remote WTRU may exclude the destination from destination selection following the indication (e.g., the destination may be excluded for a configured period of time, such as until a subsequent indication that the error condition has been resolved is received by the remote WTRU).

The WTRU may select a destination based on flow control and/or congestion indications. For example, a remote WTRU may exclude a destination from selection if the congestion level indicated by the relay (e.g., a relay WTRU) is above a threshold. For example, a remote WTRU may determine the probability of the selection of a destination based on an indicated congestion from a relay (e.g., the probability of the selection of a destination may be based on a direct relationship between the destination and the indicated congestion from a relay (e.g., each relay WTRU)).

The WTRU may select a destination based on an RRC state. For example, a remote WTRU may select a destination (e.g., a relay WTRU) which is in RRC_CONNECTED state at the time of destination selection. For example, a remote WTRU may restrict selection to a destination in RRC_CONNECTED as long as (e.g., other) conditions (e.g., as described herein) are met.

The WTRU may select a destination based on priority of the data. In examples, condition(s) (e.g., condition(s) used above) may be dependent (e.g., further dependent) on the priority of data associated with a LCH, and/or the priority of data available for transmission. For example, if the highest priority data available for transmission is above a threshold, the WTRU may use a first condition. The WTRU may use a second condition (e.g., another condition(s)) if the highest priority data available for transmission is at and/or below the threshold). For example, if the highest priority data available for transmission is above a threshold, the WTRU may select the destination with the highest RSRP. The WTRU may (e.g., otherwise) select a destination with equal probability.

Feature(s) associated with LCP restriction (e.g., based on destination) are provided herein.

The WTRU may be configured with a LCP restriction based on destination. A first LCH may be allowed to be transmitted on a grant which may be selected for a (e.g., any) destination, while a second LCH may be allowed to be transmitted on grants (e.g., only on grants) that may be selected for a specific destination. For example, a LCH may be configured with a list of allowable destinations. For example, a LCH may be configured with a list of destinations that are not allowed for transmission for that LCH. A WTRU may include in a grant (e.g., in a grant associated with a destination), the LCHs allowed for transmission to the destination (e.g., only the LCHs allowed for transmission to the destination).

The WTRU may be configured with a restriction to a condition associated with a destination (e.g., any of the conditions described herein) rather than the destination itself.

The WTRU may perform LCP based on the destination selected. The WTRU may consider logical channels based on the destination selected (e.g., based only on the destination selected).

The WTRU may include a subset of LCHs in a grant based on a selected destination if multiple destinations can (e.g., are able to and/or available to) be selected. A WTRU may determine whether to include or exclude a (e.g., specific) LCHs based on conditions which result in the selection of one or more destinations (e.g., conditions described herein).

A WTRU may, based on a condition being satisfied that a (e.g., specific) destination is selected (possibly with higher priority), include (e.g., only) LCHs in the grant that have priority above a threshold and/or are configured with a (e.g., specific) property. For example, the WTRU may determine (e.g., based on the SL RSRP of one destination being above a threshold) to select a (e.g., specific) destination with a higher priority. If the (e.g., specific) destination is selected, the WTRU may include (e.g., only) logical channels having priority larger than a threshold into the grant.

The WTRU may be configured with a LCH restriction based on destination. If a destination becomes unusable (e.g., based on conditions herein or if the destination cannot be selected, such as for a period of time), a WTRU may remove a restriction on the LCH. If a WTRU changes the probability or proportion of the selection of a destination (e.g., if a condition as described herein is met), the WTRU may remove a restriction on the LCH.

Feature(s) associated with destination selection (e.g., by the gNB) are provided herein.

A remote WTRU may select one of multiple destinations configured for a SL LCH based on a semi-static pattern (e.g., configured by the network) and/or flow control levels (e.g., received from a relay).

In examples, one or more of the following may be performed. The remote WTRU may be configured with more than one destination (e.g., more than one L2 destination) usable for a SL LCH. The remote WTRU may be configured for multiple paths via different relays (e.g., relay WTRUs). The WTRU may receive multiple destination scheduling patterns from the network (e.g., in a MAC CE). Scheduling patterns may include sequences of paths (e.g., destination ID(s)) to be selected in time when scheduling data for the multiple paths. The WTRU may receive a respective destination scheduling pattern for each flow control level (e.g., each relative flow control level), for example received from one or more of the relay WTRUs. The WTRU may receive flow control messages (e.g., from the relays) and may determine the specific destination scheduling pattern to be used based on the flow control messages. The WTRU may receive a grant (e.g., mode 1 grant) from the network. The WTRU may select a destination to be used based on a determined scheduling pattern (e.g., when the highest priority SL LCH with data available for transmission is associated with multiple destinations). The WTRU may transmit data in the grant using the selected destination. The WTRU may include the destination ID in the transmission.

The WTRU may receive a scheduling pattern (e.g., from the network).

The WTRU may receive a scheduling pattern associated with scheduling of destinations within a group (e.g., destination(s) associated with different paths to the same end destination). A scheduling pattern may comprise an ordered list of destinations and may correspond to an order of destinations (e.g., to select by the remote WTRU). For example, considering two destinations associated with different relays (e.g., relay WTRUs) to the same destination, the ordered list may be {dest1, dest1, dest2, dest2, dest2, dest1, dest2}. The WTRU, if selecting a destination for a grant, may select the destinations in the ordered list (e.g., based on the order) and may repeat such ordering. The indication of a scheduling pattern may comprise one or more destinations (e.g., to prioritize over the other destinations). For example, a prioritization of a first destination may comprise the WTRU selecting destinations with order {dest1, dest1, dest2} and repeating such ordering.

The WTRU may receive multiple scheduling patterns and may associate each scheduling pattern to flow control indications, congestion indications, and/or SL measurements from the relay (e.g., relay WTRU).

The WTRU may associate scheduling pattern(s) with flow control and/or congestion indications from a relay WTRU. For example, the WTRU may use a first scheduling pattern when congestion levels indicated by the relay WTRUs are equal, a second pattern when a first congestion level is above a second congestion level by a delta, and so on. For example, the WTRU may use a first pattern for (e.g., at least) a first flow control difference between relays, a second pattern for (e.g., at least) a second flow control difference, and so on. The flow control difference may represent a difference in the flow control levels indicated by relay WTRUs, or flow control metric(s) provided by the relay WTRU.

The WTRU may associate scheduling pattern(s) with SL measurements from a relay WTRU. For example, the WTRU may use a first scheduling pattern if the SL RSRP measurements are within a first difference, the WTRU may use a second scheduling pattern if the SL RSRP measurements are within a second difference, and so on.

The WTRU may receive a destination index and/or decision condition(s) for a destination index in DCI.

The WTRU may receive a destination index in DCI. The WTRU may select a destination for a grant based on the destination index.

The WTRU may be configured with a destination index for a destination (e.g., in RRC). If the WTRU receives a mode grant containing a destination index, the WTRU may select the destination (e.g., the destination associated with the destination index) for transmission. If the WTRU does not receive a destination index in a grant, or receives a special index associated with a (e.g., “any”) destination, the WTRU may perform destination selection based on one or more conditions (e.g., the conditions described herein).

The WTRU may be configured with a destination index associated with a group of destinations (e.g., a set of destinations associated with the same relay paths or different relay paths). A group of destinations may be associated with a different DCI type and/or signaling in the DCI. If the WTRU receives a destination index and/or a specific DCI type, the WTRU may select a destination (e.g., one of the destinations) in the destination group. The WTRU may (e.g., otherwise) select any destination, or may select a destination outside of the destination group.

The WTRU may be signaled with a destination to use implicitly based on another field associated with the DCI. The WTRU may determine whether to use a destination in a destination group based on a determination of whether a resource is scheduled on a specific carrier. For example, the WTRU may be configured with a HARQ process ID. A HARQ process ID may indicate that the grant should be used for a destination group.

The WTRU may be signaled (e.g., in DCI) to use specific conditions associated with destination selection (e.g., the conditions discussed herein), and/or which condition to use. For example, if the WTRU receives a DCI with an indication, the WTRU may select the destination with the highest measured SL-RSRP. If the WTRU receives a DCI without an indication, the WTRU may select a destination (e.g., any destination). The condition to be used when indicated in the DCI may be a condition associated with destination selection as described herein.

Feature(s) associated with BSR triggers for advanced multipath are provided herein.

A remote WTRU may be in multipath and may be configured with SL mode 1 triggers to trigger BSR (e.g., trigger BSR upon reception of a relay notification).

In examples, one or more of the following may be performed. The remote WTRU may be configured in multipath with at least two indirect paths (e.g., via two different relay WTRUs). The remote WTRU may associate a first amount of buffered data for a bearer with a first relay (e.g., a first destination ID) and may associate a second amount of data for a bearer with a second relay (e.g., a second destination ID). The WTRU may re-associate data for the first relay (e.g., all data for the first relay) to the second relay (e.g., upon reception of a failure indication from the first relay WTRU, such as a Uu RLF). The WTRU may (e.g., upon reception of a failure indication from the first relay WTRU, such as a Uu RLF) trigger a BSR and transmit a report of the amount of buffer data associated with the second relay (e.g., the updated amount including the first amount of data and second amount of data). Feature(s) associated with BSR reporting for a destination group (e.g., based on destination index) are provided herein.

The WTRU may report a single buffer status for data (e.g., all data) that can be transmitted via multiple relay WTRUs (e.g., a single buffer status for all destination IDs in a group).

SL buffer status associated with multiple relay WTRUs may be reported by the WTRU, e.g., by grouping the different relay WTRUs associated with the same end destination together and reporting a single buffer status associated with each of them (e.g., report, using a single value, a respective buffer status for all of the relay WTRUs used for sending to the same destination). The remote WTRU may be configured with a set (e.g., list) of relay WTRUs (e.g., destination L2 IDs, relay IDs, or any other IDs) that are associated with the transmission of data to the same end destination point (e.g., the network-in case of U2N relays, or a peer WTRU-in case of U2U relays, e.g., both of which may be used interchangeably in examples provided herein to describe an end destination point). For example, the WTRU may be configured in RRC with a set of WTRU to NW relay WTRUs that can serve as the transmission target for one or more logical channels. For example, a WTRU may be configured with a single set of LCHs (e.g., LCHs associated with multiple L2 destination IDs). A WTRU configured with a single set of LCHs may infer a destination group based on the mapping. For example, a WTRU may select a set of relay WTRUs (e.g., based on relay selection condition(s) and/or procedure) to be used for a (e.g., single) destination (e.g., network-in the case of U2N, or other WTRU-in the case of U2U). The WTRU may report the set of relay WTRUs corresponding to the group (e.g., together in SidelinkWTRUInformation) to the network.

The WTRU may be configured with a SL destination index to be used when transmitting BSR corresponding to multiple L2 destination IDs. In examples, one or more of the following may be performed. The WTRU may receive (e.g., in dedicated RRC signaling) a SL destination index and the associated L2 destination ID(s). The WTRU may infer a mapping between an available destination index (e.g., the next available destination index following mapping between other destination indices and L2 destination IDs) and each grouping of L2 destination IDs associated with a destination group. The WTRU may receive a dedicated destination index to be used with a group of L2 destination IDs (e.g., possibly reported by the remote WTRU). The WTRU may apply the destination index associated with the first L2 ID of the group of L2 destination IDs (e.g., while skipping the association of any destination index with any of the other L2 destination IDs reported). The WTRU may indicate (e.g., using a dedicated IE in a SidelinkWTRUInformation message) the destination L2 IDs associated with another L2 ID (e.g., the first reported L2 ID) and may skip association of a destination index with that L2 ID (e.g., the destination L2 ID(s).

The WTRU may report BSR for one or more LCHs that may be configured to be usable over multiple L2 destination IDs (e.g., paths or relays) using the single destination index associated with the destinations.

The WTRU may report buffer status separately for data routed via a (e.g., each) relay WTRU. A different buffer status may be reported by the WTRU for each L2 ID in the group.

The WTRU may be configured with different LCHs over the different destinations (e.g., associated to different relays). The WTRU may report buffer status for a (e.g., each) LCH associated with the different destinations.

Feature(s) associated with new SR/BSR trigger are provided herein.

The WTRU may associate data to be transmitted to the same end destination (e.g., with multiple relay WTRUs, for example destination IDs) with the group of relay WTRUs. The WTRU may use similar condition(s) (e.g., the condition(s) discussed herein) for selection of a destination (e.g., an L2 destination ID) in LCP (e.g., in order to perform the association of the data with the group of relay WTRUs).

The WTRU may re-associate data in the buffers for transmission to a relay WTRU (e.g., one relay WTRU) of a group of relay WTRU(s) to another relay(s) (e.g., upon an event). The WTRU may trigger SR/BSR. The WTRU may change the reported buffer status associated with one or more destinations (e.g., L2 destination IDs). The one or more destinations (e.g., L2 destination IDs) may be associated with a group based on the WTRU triggering SR/BSR.

The WTRU may trigger SR/BSR based on one or more of the following conditions: whether a notification message (e.g., from the relay WTRU) is received; whether a SL RLF is declared on a relay WTRU; whether the amount of data associated to one or more destinations (e.g., L2 destination IDs) in the group is changed (e.g., by a (pre)configured threshold); whether a LBT failure occurred on one path, but not on another path; or whether a change (e.g., any change) in the amount of data occurred (e.g., due to re-association based on condition(s) described herein for destination selection).

The WTRU may trigger SR/BSR based on reception of a notification message from a relay WTRU. The notification message may include one or more of: a Uu RLF notification message, a SL RLF notification of the next hop, a change of RRC state of the relay WTRU (e.g., a change from RRC_CONNECTED to RRC_IDLE/RRC_INACTIVE or vice versa), a RRC connection failure (e.g., by the relay WTRU), HO, or reselection (e.g., by the relay WTRU). For example, upon receiving a Uu RLF notification message from a first relay WTRU associated with a group of relays, the WTRU may trigger BSR after associating the data to be transmitted via the first relay WTRU to a different relay WTRU.

The WTRU may trigger SR/BSR based on SL RLF declared on a specific relay WTRU.

For example, upon detection of SL RLF and/or release of the unicast link with a first relay WTRU, the WTRU may trigger BSR after associating the data to be transmitted via the first relay WTRU to other relay WTRU(s) of the group.

The WTRU may trigger SR/BSR based on a change in the amount of data associated to one or more destinations (e.g., L2 destination IDs) in the group (e.g., by a (pre)configured threshold). For example, if at least a configured amount of data associated with relay WTRU 1 is re-associated to one or more other relay WTRU(s) in the group, the WTRU may trigger SR/BSR.

The WTRU may trigger SR/BSR based on an LBT failure occurring on a (e.g., one) path, but not on another path. For example, if LBT failure occurs upon transmission to one relay WTRU, and the remote WTRU is able to transmit to a different relay WTRU (e.g., due to the use of a different carrier or different set of resources), the remote WTRU may reassociate the data to a different relay WTRU and/or trigger BSR.

The WTRU may trigger SR/BSR based on a (e.g., any) change in the amount of data that occurs due to re-association (e.g., based on condition(s) described herein for destination selection). For example, the WTRU may trigger SR/BSR based re-associated due to one or more of: a flow control indication, a flow control difference between paths, a SL RSRP measurement difference between paths, and/or the like.

The WTRU may report an indication of the re-association using a message to the network (e.g., MAC CE, RRC message) without a BSR. The WTRU may be (pre)defined or (pre)configured with a rule for re-associating data to one or more other WTRUs in the group. For example, the WTRU may re-associate data (e.g., all data) with the next destination (e.g., L2 destination ID) in the reported group. For example, the WTRU may re-associate an equal amount of data to (e.g., all) destinations (e.g., L2 destination IDs) in the group. For example, the WTRU may re-associate an amount of data to (e.g., all) destinations (e.g., L2 destination IDs) using (pre)determined or (pre)configured rules based on condition(s) (e.g., condition(s) described herein). For example, the WTRU may re-associated an amount of data to a (e.g., all) destinations (e.g., L2 destination IDs) using rules based on RSRP, flow control, and/or the like.

The WTRU may report re-association information to the gNB (e.g., in a MAC CE, or RRC message). For example, a WTRU may indicate (e.g., using different IE) whether data is re-associated equally to different relay WTRUs, whether data is re-associated to a single relay WTRU (e.g., the specific relay WTRU), and/or the like.

Feature(s) associated with resource (re)selection trigger for multipath are provided herein.

In examples, one or more of the following may be performed. The remote WTRU may be in multipath and configured with SL mode 2. The remote WTRU may trigger reselection upon reception of a relay notification. The remote WTRU may be configured with destinations (e.g., two L2 destinations) associated with different relays usable for a SL LCH (e.g., multiple paths via different relays). The WTRU may be configured with a PDB value for each of the destinations (e.g., relay WTRUs). The WTRU may trigger resource reselection for a resource already selected if a failure indication from the first relay WTRU is received (e.g., Uu RLF, flow control) and/or if the PDB values for the different destinations are not equal. The WTRU may transmit data to any of the non-failed paths (e.g., using the newly selected resources).

Feature(s) associated with triggers for resource reselection when transmitting to different relay WTRUs are provided herein.

The WTRU may trigger resource reselection based on one or more events (e.g., as described herein). The WTRU may trigger resource reselection based on event(s) associated with one or more relay WTRUs (e.g., one or more relay WTRUs that may be associated with a group of relays). For example, a remote WTRU transmitting in mode 2 with a resource selected and/or indicated (e.g., via an indication in SCI) may trigger a resource reselection upon a failure associated with a relay WTRU, a message received from one or more relay WTRU, or a similar condition (e.g., as described herein). The triggers may correspond to any failure condition(s) described herein, including receiving a notification from a relay WTRU, determining SL RLF (e.g., by the remote WTRU), determining LBT failure (e.g., by the remote WTRU), and/or the like. The trigger for resource reselection may comprise a condition associated with condition(s) (e.g., as described herein), including condition(s) for changing the data routed via a different relay, condition(s) for changing the selection of a destination, and/or the like.

Resource reselection may be conditioned on one or more of the following: PDB of one or more of the paths; PDB of a combination of the failed path(s) or the non-failed path(s); the resource selection window used to select the specific resource; the priority of the data; the QoS of the data; LCP restrictions currently active (e.g., restrictions that may be associated with data available for transmission at the time of failure); or a condition associated with the measured CBR.

Resource reselection may be conditioned on a PDB of the path(s) or a PDB of a combination of the failed path(s) and non-failed path(s). Resource reselection may be conditioned on one or more of the following conditions: whether the PDB associated with the different relays are different or differ by at least a threshold amount; whether the resource is within the PDB of a relay (e.g., to which a failure is determined); or whether the resource is outside of the PDB of one, some, or all relays (e.g., relays which are determined to not have failed). For example, a remote WTRU may trigger resource reselection if the remote WTRU receives a failure indication from a relay and/or if the PDB of the relay is different, less than, or greater than the PDB of another (e.g., non-failed) relay (e.g., a relay that may be associated with the same destination (e.g., be a different path) by a threshold amount of time or slots). For example, a remote WTRU may trigger resource reselection if the remote WTRU receives a failure indication from a relay and if the PDB of the relay is different than any other relay associated with the same destination.

Resource reselection may be conditioned on the resource being within the PDB of a relay for which failure is determined. For example, a remote WTRU may trigger resource reselection if the remote WTRU receives a failure indication from a relay, and the resource is within the PDB of the failed relay (e.g., the relay for which the failure was received).

Resource reselection may be conditioned on the resource being outside of the PDB of one, some, or all relays that is/are determined as not failed. For example, a remote WTRU may trigger resource reselection if the remote WTRU receives a failure indication from a relay, and the resource is outside one of the following: at least one of the non-failed relays (e.g., the other relays associated with the group and not indicating a failure); a threshold number or percentage of the non-failed relays; or all of the non-failed relays.

Resource reselection may be conditioned on the resource selection window used to select the resource (e.g., if the WTRU used the minimum or the maximum PDB of the PDBs configured for the different relay WTRUs and/or if the window used for resource selection corresponds to the PDB of the failed relay WTRU). For example, the remote WTRU may trigger resource reselection if the remote WTRU selected the resource selection window based on the use of the maximum PDB of the relays allowable for transmission. For example, the remote WTRU may trigger resource reselection of a failed relay WTRU that was associated with the maximum PDB.

Resource reselection may be conditioned on the priority and/or QoS of the data. For example, the WTRU may trigger resource reselection if the priority of pending data available for transmission at the time of the relay failure indication is above a threshold.

Resource reselection may be conditioned based on LCP restrictions currently active (e.g., restrictions that may associated with data available for transmission at the time of failure). For example, the remote WTRU may trigger resource reselection if, as a result of a relay WTRU failure, one or more logical channels are not allowable for transmission on any SL grant (e.g., due to LCP restrictions associated with that logical channel and the current SL grants). For example, the remote WTRU may trigger resource reselection if one or more logical channels have data available for transmission, and the data available for transmission is allowed to be transmitted on the path of the relay that indicated the failure.

Resource reselection may be based on a condition associated to the measured CBR. For example, reselection may be triggered if the measured CBR is below or above a threshold. For example, reselection may be triggered if the measured CBR is below or above the value measured when resource selection associated with the resource in question was first performed (e.g., by a threshold amount).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor.

Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1. A wireless transmit/receive unit (WTRU) comprising:
a processor configured to:
receive information that indicates a first packet delay budget (PDB) associated with a first relay WTRU and a second PDB associated with a second relay WTRU;
determine that there is data to be sent;
determine a resource selection window based on one condition of a first condition or a second condition being satisfied, wherein the first condition being satisfied comprises that a congestion indication is received from the second relay WTRU and the second PDB is larger than the first PDB, and wherein the second condition being satisfied comprises that the congestion indication is not received from the second relay WTRU, the second PDB is larger than the first PDB, and a channel busy ratio (CBR) meets or is greater than a threshold;
determine a resource within the determined resource selection window; and
send the data, wherein the data is sent via at least the determined resource.

2. The WTRU of claim 1, wherein the one condition that is satisfied is the first condition, and wherein the processor is further configured to:
based at least on the reception of the congestion indication from the second relay WTRU and the second PDB being larger than the first PDB, determine that the resource selection window is the first PDB.

3. The WTRU of claim 2, wherein the determination that the resource selection window is the first PDB comprises a determination to use a value of the first PDB for the resource selection window.

4. The WTRU of claim 2, wherein the determination that the resource selection window is the first PDB is further based on the first PDB being a smallest PDB among relays available to the WTRU for transmission of the data.

5. The WTRU of claim 1, wherein the one condition that is satisfied is the second condition, and wherein the processor is further configured to:
based at least on the lack of the reception of the congestion indication from the second relay WTRU, the second PDB being larger than the first PDB, and the determination that the CBR meets or is greater than the threshold, determine that the resource selection window is the second PDB.

6. The WTRU of claim 5, wherein the determination that the resource selection window is the second PDB is further based on the second PDB being a maximum PDB among relays available to the WTRU for transmission of the data.

7. The WTRU of claim 5, wherein the processor is further configured to determine the CBR.

8. The WTRU of claim 1, wherein, the processor is further configured to:
based on the determined resource being after one PDB of the first PDB or the second PDB, determine that there is a restriction for a sidelink logical channel associated with a relay WTRU that is associated with the one PDB, wherein the relay WTRU is the first relay WTRU or the second relay WTRU;
determine a smallest PDB from among the first PDB or the second PDB; and
select the first relay WTRU if the first PDB is the smallest PDB or select the second relay WTRU if the second PDB is the smallest PDB.

9. The WTRU of claim 1, wherein the determination that there is data to be sent triggers the determination of the resource selection window.

10. A method associated with a wireless transmit/receive unit (WTRU), the method comprising:
receiving information that indicates a first packet delay budget (PDB) associated with a first relay WTRU and a second PDB associated with a second relay WTRU;
determining that there is data to be sent;
determining a resource selection window based on one condition of a first condition or a second condition being satisfied, wherein the first condition being satisfied comprises that a congestion indication is received from the second relay WTRU and the second PDB is larger than the first PDB, and wherein the second condition being satisfied comprises that the congestion indication is not received from the second relay WTRU, the second PDB is larger than the first PDB, and a channel busy ratio (CBR) meets or is greater than a threshold;
determining a resource within the determined resource selection window; and
sending the data, wherein the data is sent via at least the determined resource.

11. The method of claim 10, wherein the one condition that is satisfied is the first condition, and wherein the method further comprises:
based at least on the reception of the congestion indication from the second relay WTRU and the second PDB being larger than the first PDB, determining that the resource selection window is the first PDB.

12. The method of claim 11, wherein the determination that the resource selection window is the first PDB comprises determining to use a value of the first PDB for the resource selection window.

13. The method of claim 11, wherein the determination that the resource selection window is the first PDB is further based on the first PDB being a smallest PDB among relays available to the WTRU for transmission of the data.

14. The method of claim 10, wherein the method further comprises determining the CBR.

15. The method of claim 10, wherein the method further comprises:
based on the determined resource being after one PDB of the first PDB or the second PDB, determining that there is a restriction for a sidelink logical channel associated with a relay WTRU that is associated with the one PDB, wherein the relay WTRU is the first relay WTRU or the second relay WTRU;
determining a smallest PDB from among the first PDB or the second PDB; and
selecting the first relay WTRU if the first PDB is the smallest PDB or selecting the second relay WTRU if the second PDB is the smallest PDB.
